(19) United States
(12) Patent Application Publication
(10) Pub. No.: US 2007/0288482 A1
(43) Pub. Date: Dec. 13, 2007

(54) RFID Workflow Client

(75) Inventor: Marina Yurievna Popova, Arlington, MA (US)

Correspondence Address: FLIESLER MEYER LLP, 650 CALIFORNIA STREET, 14TH FLOOR, SAN FRANCISCO, CA, 94108, US

(73) Assignee: BEA SYSTEMS, INC., San Jose, CA (US)

(21) Appl. No.: 11/759,780

(22) Filed: Jun. 7, 2007

Related U.S. Application Data
(60) Provisional application No. 60/812,397, filed on Jun. 9, 2006.
(60) Provisional application No. 60/812,460, filed on Jun. 9, 2006.
(60) Provisional application No. 60/866,727, filed on Nov. 21, 2006.

(51) Int. Cl. G06F 17/30

(52) U.S. Cl. 707/10

(57) ABSTRACT

An RFID edge server can receive RFID data from at least one RFID reader. A thin client application can communicate with the RFID edge server. The thin client can run in an application container and provide for a UI display.

### CLAIM OF PRIORITY

This application claims priority to U.S. Provisional Application No. 60/812,397 entitled “Edge Server” by Traub et al., filed Jun. 9, 2006 [Atty. Docket No. BEAS-02086US0]; and U.S. Provisional Application No. 60/812,460 entitled “Enterprise Server” by Traub et al., filed Jun. 9, 2006 [Atty. Docket No. BEAS-02087US0]; and U.S. Provisional Application No. 60/866,727 entitled “RFID Workflow Client” by Popova, filed Oct. 21, 2006 [Atty. Docket No. BEAS-02097US0]; which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

Radio Frequency Identification (RFID) systems are becoming increasingly more popular. In an RFID system, RFID tags are used to track products. In one embodiment, a number of RFID readers at a location send data to a local RFID edge server. The RFID edge server can then transfer RFID data to an RFID Enterprise Server.

The RFID edge server can run workflows that allow for RFID processes to occur at the RFID server. An exemplary RFID workflow may be the creation and testing of a RFID tag for a product.

### BRIEF DESCRIPTION OF THE DRAWINGS

FIG. 1 is an exemplary RFID system.

FIG. 2 is an RFID system with a thin client.

FIGS. 3A-3E illustrates exemplary user interface screens.

FIGS. 4A-4D illustrates exemplary screens for a CPA verification user case.

FIG. 5 illustrates an exemplary RFID thin client architecture.

FIG. 6 illustrates an RFID thin client as a stand alone in a web container.

FIG. 7 illustrates and RFID thin client deployed in a J2EE enterprise server.

FIG. 8 illustrates an RFID thin client as a web application in the same web container as an RFID edge server.

FIG. 9 illustrates an RFID thin client in the same J2EE application server as an RFID edge server.

FIG. 10 illustrates an RFID thin client in the same J2EE application server as an EPCIS server.

FIGS. 11A-11B illustrate synchronous and asynchronous calls from the client to RFID workflow

### DETAILED DESCRIPTION

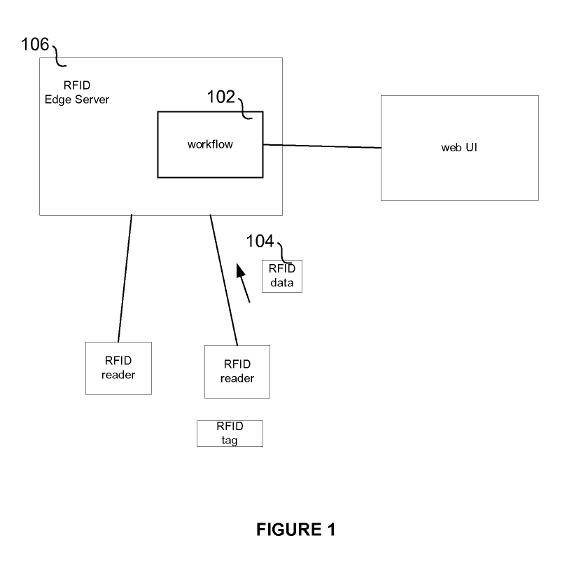

FIG. 1 shows an exemplary system 100 including an RFID workflow 102 that uses RFID data 104 to do an RFID process. A web-based UI 106 can interact with the RFID workflow 102. The interaction can include receiving input from a user or other actions.

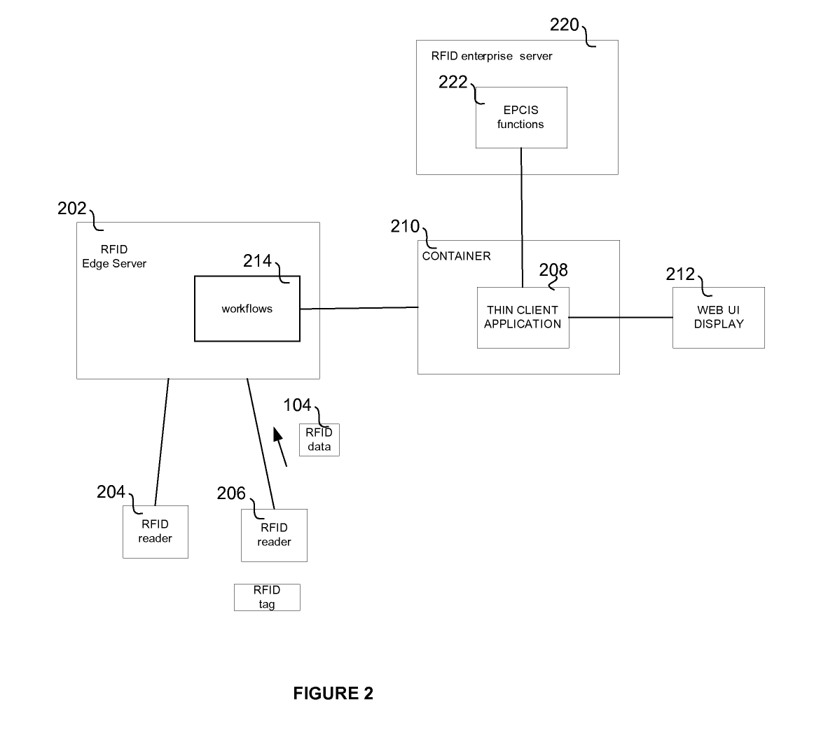

FIG. 2 shows an example where an RFID edge server 202 receives RFID data from at least one RFID reader 204 and 206. A thin client application 208 can communicate with the RFID edge server 202. The thin client application 208 can be run in an application container 210 and can provide for a User Interface (UI) display 212. The UI display 212 can be a web UI display. The thin client application 208 can be in a web container or J2EE application container. The thin client application can be placed in an archive file such as a Java Archive (JAR), Enterprise Application Archive (EAR), or Web Archive (WAR). The RFID edge server 202 can run in an application container along with or separate from the thin client application 208. The thin client application can include a listener. The thin client application 205 can communicate with an RFID Enterprise Server 220 that does Electronic Product Code Information Service EPCIS functions 222. The UI can allow users interact to the RFID workflow 214.

One embodiment of the present invention is a thin client application 208 to run in an application server 210. The thin client application can communicate with an RFID edge server 202. The thin client application can provide a UI display 212.

Stand alone clients can communicate with the Workflow components and Enterprise Server.
1. A Thin client can be a Web application running in a container such as
   A Tom Cat Web Server, or
   A WebLogic Server available from BEA Systems, Inc. of San Jose, Calif.
2. RFID edge server and Workflow Framework (WF) can be run as a stand alone application, possibly on a different server than the Web client.
3. The application can be deployed as an archive file in the same container as the Web Client.
4. Communication between the RFID edge server and the workflow and the Web Client can be optimized for a specific deployment; however, a generic communication mechanism can exist that applies to all deployments.

There can be different deployment options for the RFID edge server and the workflow and a Thin Client. This can have ramifications on the RFID edge server, client communication protocols and the client implementation.

One option would be to deploy the RFID edge server and, framework WAR, Client EAR and EPCIS EAR in the same container. In that case, all communication between components could be done via Java calls in the same Java Virtual Machine (JVM), avoiding SOAP overhead.

When considering different deployment options and corresponding proposed architectural approaches, the following aspects can focused on:

A. Communication Protocols:
the RFID edge server and the workflow→Client
Client→the RFID edge server and the workflow
Deployment (and protocol)-specific components on the Client and/or RFTA sides

B. Interface
Change in the RFID edge server and/or the Client interfaces to support the architecture

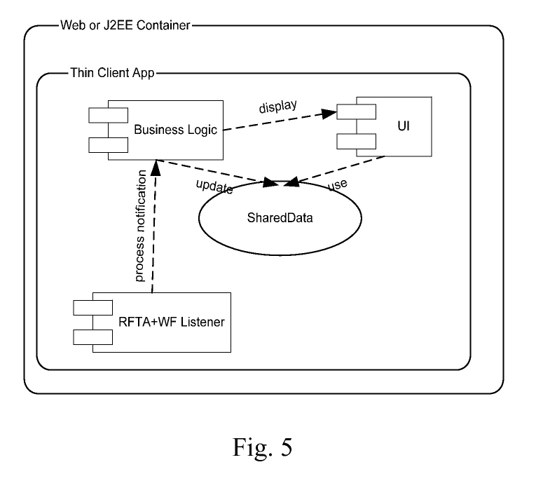

The general architecture of the thin client can be represented as shown FIG. 5.

The Thin client, regardless of the deployment type, can contain the following components:

C. Client Components:
1. RFID edge server/workflow Listener—can be a component responsible for accepting notifications and/or requests from the RFID edge server and the workflow. They could be Hypertext Transfer Protocol (HTTP) or Java Messaging Service (JMS) notifications or direct Remote Method Invocation (RMI) or Java calls.
2. Business Logic module—can be responsible for processing the RFID edge server request and can perform client-specific business functionality (for example, implement the First-In-First-Out (FIFO) logic in the Albertson's FIFO use cane).
3. Shared Data component—can be the state of the thin client, with all business data, that is available to the user interface (UI) component for presentation. It is accessible from the Business Logic module for modification.
4. UI component(s) can be responsible for the presentation; uses the shared data component.

Depending on the deployment options, these four components can be implemented differently. The following architectural approaches are proposed for different types of deployments. For each type of deployment there can be different design choices for protocols, interfaces and client components noted above.

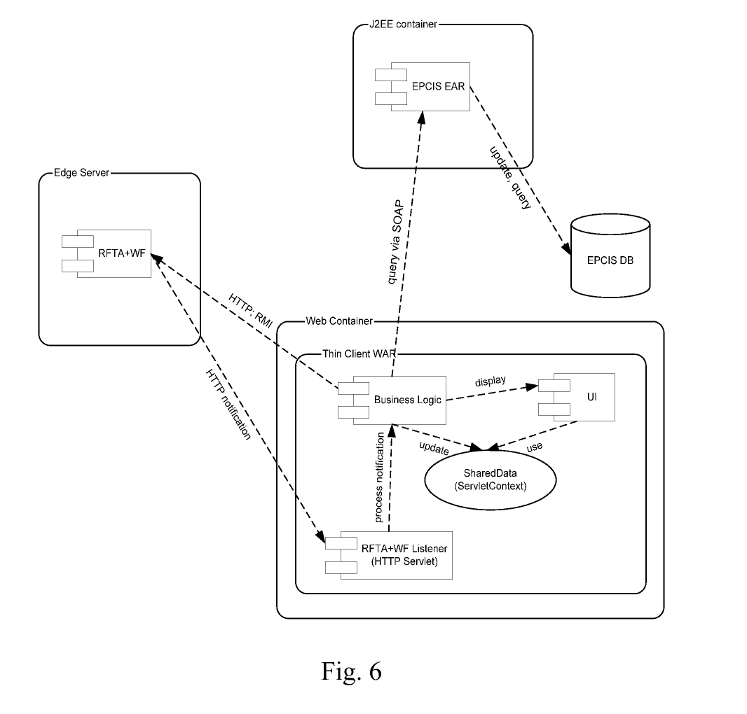

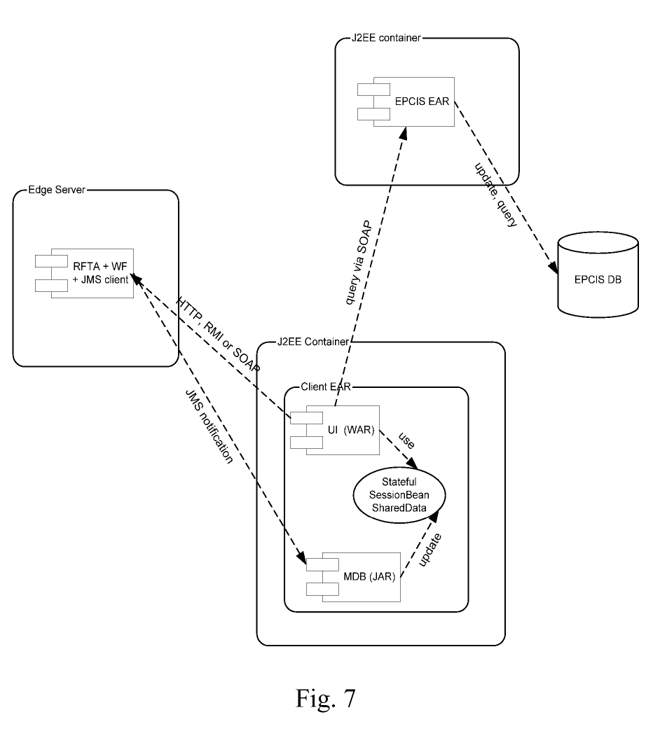

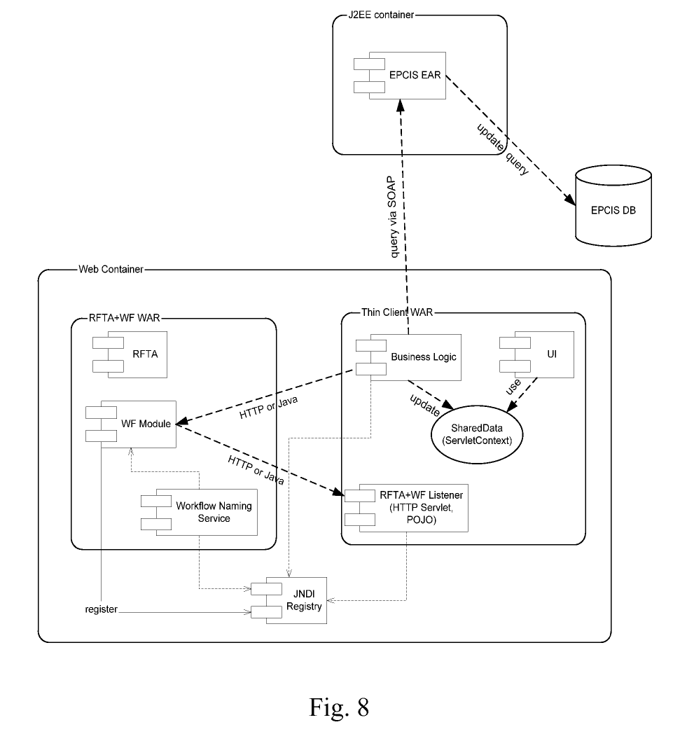

FIG. 6 shows a stand alone the RFID edge server and the workflow, thin client as a web application deployed in a web container (such as Tomcat or WebLogic Server).

Exemplary Design Choices:

A. Protocols
1. RFID edge server and the workflow→WebClient
   HTTP notification with SerializableMessages as a payload
2. WebClient→RFID edge server and the workflow
   1. HTTP notifications with SerizlizableMessages as a payload
   2. Remote method invocation (RMI) calls
   3. SOAP (but won't consider this protocol for now due to potential. Serialization complexities)

B. Interface Discussed Below

C. Client Components
1. RFID edge server and workflow listener—HTTP servlet listening for HTTP notifications
2. Business logic module—Plan Old Java Object (POJO)
3. Shared data—POJO kept in the ServletContext, or more reliable persistent storage, like database, if required

The main design decision that has to be made in this deployment scenario is the choice of the communication protocol between the WebClient and the RFID edge server and workflow.

The two main choices are HTTP and RMI protocol. This will consider implications of each of them below.

HTTP Notification

To implement a HTTP notification between WebClient and RFID edge server, the following can be used:
a HTTP Listener can run in the RFID edge server and the workflow server. A new AbstractHTTPListener class in the HTTPMessage VCC component can be used for that. A specialized WorkflowHTTPListener can extent the AbstractHTTPListener and implement its processRequest( ) method.
At the RFID edge server and workflow initialization time, RFTA can start the WorkflowHTTPListener and pass it a reference to the Workflow2NamingService
When a HTTP request comes in, the processRequest( ) method can:
   Receive an HTTP request and process its body. The HTTP request has to contain at least the following: name of the destination Workflow Framework module; SerializableMessage object
   Lookup the specified Workflow Framework Module
   Pass the message to the module via a module.receivedMessage (message M) call

Consequences of this Design
A. In one embodiment, communication between WebClient and RFID edge server and the workflow can be asynchronous only.
B. WebClient may have to know how to create SerializableMessages and which workflow module to send them to
C. Only SerializableMessages can be passed in the HTTP notification. In one embodiment, this means, the message itself have to know how to serialize/deserialize itself (such as using Java Architecture for XML Binding (JAXB))

RMI Communication

To utilize the RMI protocol, the following can be done:
an RMI registry can be run on the server. Most likely, it can be RFID edge server that starts the RMI registry on the server startup
WorkflowNamingService and workflow modules can expose Remote interfaces, stubs and skeletons have to be created for all of them using ‘rmic’ (the Java RMI compiler) and the can be registered in the RMI registry.
There are a few ways to go about this:
   Each Workflow Framework module is registered in the RMI registry and Web Client can look up the modules directly and invokes their remote methods
   Only WorkflowNamingService need be registered in the RMI registry, and it returns references to the remote Workflow Framework modules when the WebClient asks for them
   A new WorkflowRMIService remote object can live in the RFID edge servers Java Virtual Machine (JVM) and act as both an RMI proxy and a façade to the RFID edge server and the workflow. The WorkflowRMIService can be registered with the RMI registry and expose a method of type:
      Public Object CallModuleMethod (String moduleName, String methodName, Object[ ] methodparameters);
      When the WebClient calls this method, WorkflowRMIService can look up the Workflow Framework module, and invoke the specified method using Java Reflection.
      Method parameters can be Serializable, but WorkflowNamingService and Workflow Framework modules do not have to be exposed as remote objects.

Consequences of this Design
A. RMI Registry may need to be run on the server
B. Communication between WebClient and RFID edge server and the workflow may need to be synchronous. It is possible to supply asynchronous methods that delegate to the synch methods
C. WebClient may need to know APIs of all Workflow Framework modules
D. Workflow modules' remote method parameters may have to be Serializable or implement Remote interface.
E. Changes may need to be made to the current RFID edge server and workflow framework

FIG. 7 shows a stand alone RFID edge server and the workflow, thin client as an EAR application deployed in a J2EE application server (WLS)

Communication Mechanisms:
1. RFID edge server and the workflow→thin client via JMS notification (may require client JMS libraries)
2. Thin client→RFID edge server and the workflow via HTTP, RMI or SOAP
3. Thin client→EPCIS via SOAP

FIG. 7 shows RFID edge server and the workflow as a WAR, Thin Client as a Web application deployed in the same Web container.

Design Choices:
A. Protocols
   1. RFID edge server and the workflow→WebClient
      HTTP notifications with SerializableMessages as a payload
      Java calls to the Business Logic module directly
2. WebClient→RFID edge server and the workflow HTTP notifications
   Java calls to the WorkflowNamingService and Workflow Framework modules in the same JVM
B. Interfaces Discussed Below
C. Client Components
   1. RFID edge server and the workflow Listener can be a HTTP Servlet listening for HTTP notifications or a POJO bound to a common Java Naming and Directory Interface (JNDI) registry (for direct Java calls)
   2. Business Logic module can be POJO (possibly bound in the global JNDI registry)
   3. Shared Data can be POJO kept in the ServletContext, or more reliable persistent storage, like database, is required

Communication between RFID edge server and the workflow and the WebClient can be:
1. HTTP notification; or
2. Direct Java calls

To implement this option, the following has to be done:
RFID edge server and the workflow Listener can be implemented as a POJO bound to the JNDI registry assessable to both RFTA and the WebClient; it can thread-safe
A new RFID edge server module can be created that would accept calls/notifications from other Workflow Framework modules and call the RFID edge server Listener POJO as required
RFID edge server Listener can accept the request and convert them to appropriate calls to the Business Logic module. To enable direct calls from the RFID edge server Listener to the Business Logic module, either Business Logic module can be bound in the JNDI registry, or RFID edge server Listener has to live in the WebClient (to use the same classloader)
There are other container specific options for sharing classloaders: Tomcat provides a so-called “shared classloader” that hosts classes visible in both web application; and WebLogic Server allows on to specify custom classloading hierarchies provided that both Web apps are deployed in on EAR

Communication between WebClient and RFID edge server and the workflow
1. HTTP notification to Workflow Framework modules—the same as above
2. Java calls to the WorkflowNamingService and Workflow Framework modules

Additional implementation details can be:
WorkflowNamingService can be bound to the global JNDI registry
WebClient can have to lookup the WorkflowNamingService, lookup required Workflow Framework module, and call module's business API methods (proviced that classloading issues are resolved)
Another option is to bind all Workflow Framework modules in the global JNDI registry as well and have the WebClient look them up and call directly
Yet another option is to have a separate WFJavaService, analogous to the WorkflowSOAPService and WorkflowRMIService, that would act as a proxy and façade the to Workflow Framework modules

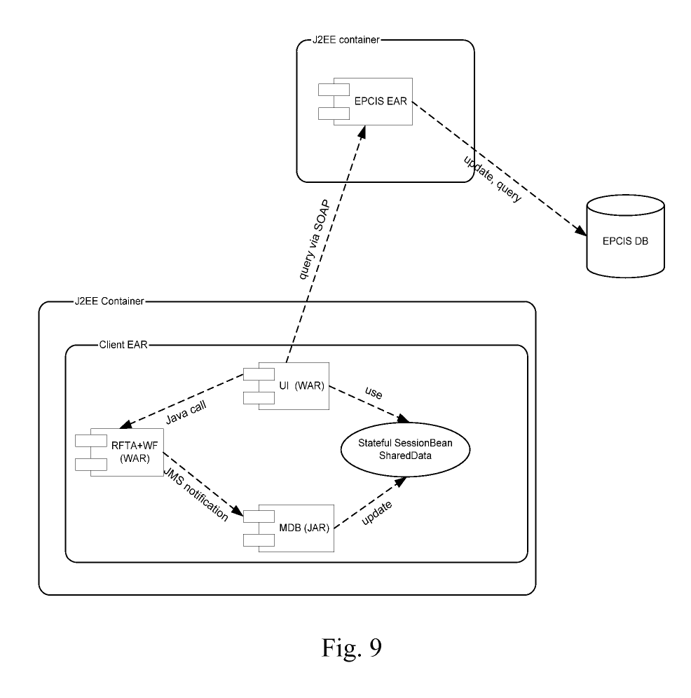

FIG. 9 shows RFID edge server and the workflow, thin client as an EAR application deployed in the same J2EE application server (WLS)

Communication Mechanisms can Include”
3. RFID edge server and the workflow→Thin client via JMS notification
4. Thin client→RFID edge server and the workflow via Java calls
5. Thin client→EPCIS via SOAP

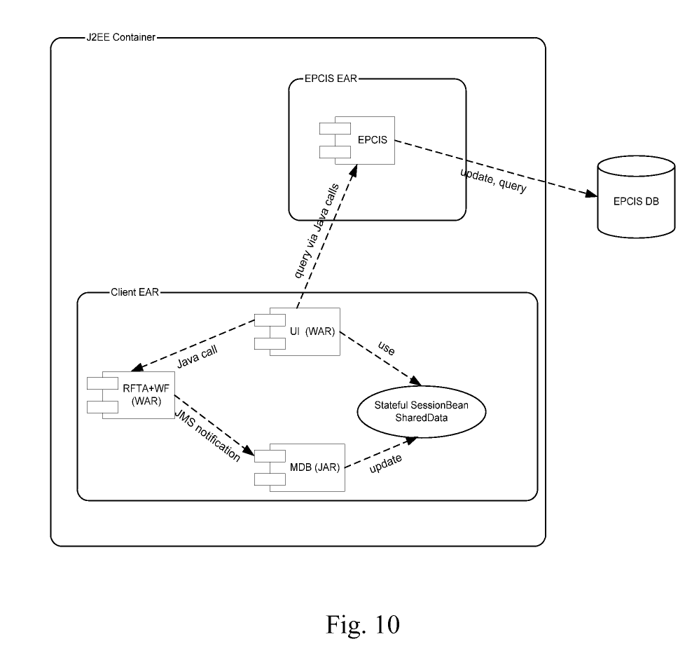

FIG. 10 shows RFID edge server and workflow WAR and Thin client as an EAR application, EPCIS EAR are all deployed in the same J2EE container (WLS)

Communication Mechanisms:
6. RFID edge server and the workflow→Thin client via JMS notification
7. Thin client→RFID edge server and the workflow via Java call
8. Thin client→EPCIS via Java call

In order to implement thin client application in a generic way, when the RFID edge server and workflow is deployed as a stand alone application in a JVM separate from the clients JVM, the following communication mechanisms can be provided.
1. RFID edge server and the workflow→Thin client via HTTP notification
2. Thin client→RFID edge server and the workflow via SOAP
3. Thin client→EPCIS via SOAP

To provide a SOAP interface to RFID edge server and the workflow the following approaches could be taken:
1. Each workflow module can expose a SOAP interface. The WorkflowNaminingService can also expose a SOAP interface that would allow a client to look up existing Workflow Framework modules and use their exposed SOAP APIs.
2. A SOAP Proxy, let say WorkflowService, can be created that exposes a generic API that allows users to specify which module and which functionality of that module they wan to exercise. The WorkflowService can accept the SOAP requests, determine which modules they are intended for, delegate requests to those modules via existing non-SOAP APIs, receive responses, convert them into SOAP responses and return the responses back to the client.

Two modes of communication can be provided: synchronous and asynchronous. For a synch communication the messaging framework utilized for inter-module communication could be used. The results of the actions would be sent to the WebClient through existing HTTP notification mechanism.

The WorkflowService public API can look as following:
1. public object callModuleMethod (string moduleName, String methodName, object [ ] method Parameters)
   lookup workflow module “moduleName”->moduleToCall
   invoke the “methodName” method of the module with the passed methodParameters
   return the result to the caller as an Object
2. public void call ModulePor(String moduleName, Message in Message)
   lookup workflow module “moduleName”->moduleToCall
   invoke the moduleToCall.receiveMessage (in Message)
   the results of the module work will be passed to the WebCLient through HTTP notification
3. public void ccaaModulePort (String moduleName, String messageType, Collection message Parameters)
   create a GenericMEssage of a specific message of type “messageType”
   set parameters of the message to the passed in “messageParameters”
   proceed as in the previous API method

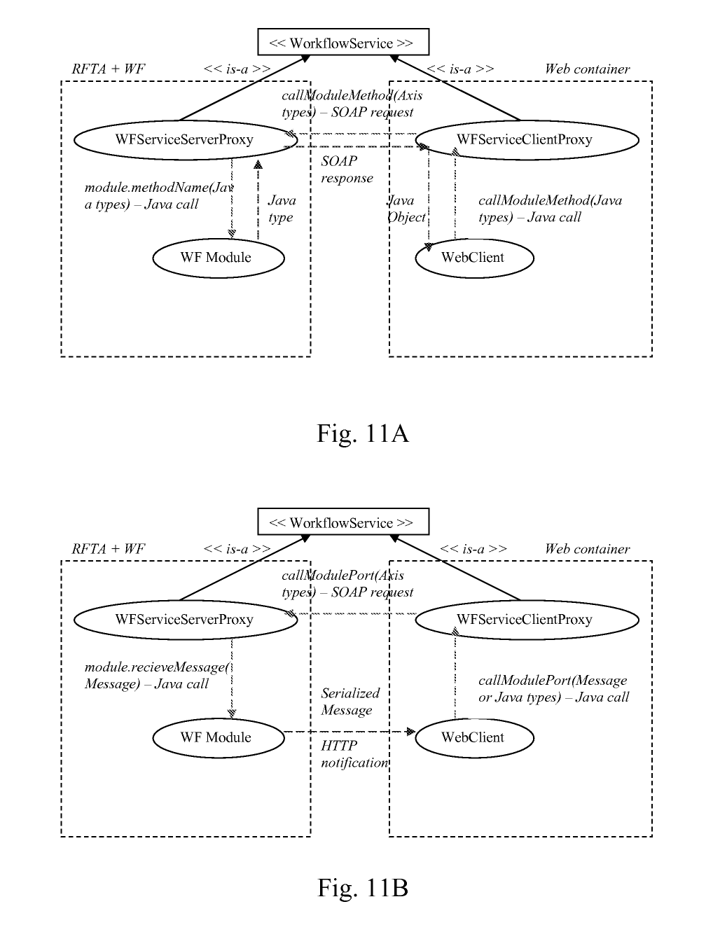

FIG. 11A shows a synchronous call from WebClient to a Workflow Module.

FIG. 11B shows asynchronous call from WebClient to RFID edge server and the workflow.

Examples of using the SOAP communication protocol between a WebClient and RFID edge server and workflow.

### Exemplary Use Case

To illustrate the use of the SOAP protocol between a WebClient and RFID edge server and the workflow we can consider a use case when a WebClient needs to turn a stacklight's green color on.

Configuration parameters (or local variables set to specific values by a business process):
String stacklightModuleName=“StackLight1”
StackLightColor color=“green”
Long stacklightTimeout=0
String stacklightAction=“on”

Local Variables:
WorkflowService wfservice=new WFServiceClientProxyo

Synchronous Call Process Flow:
1. String methodName=“setStackLight”
2. Create Collection nethodParameters
3. methodParameters.put (color, stacklightTimeout, stacklightAction)
4. Object result=wfService.callModuleMethod (stacklightModuleName, methodName, methodparameters); [Since the ‘setStackLight( )” method is of void type—the result will be null, just ignore it]

WFServiceClientProxy—in callModuleMethod( )
5. warp all primitive methodParmaters members into Java Object types and, if necessary, into Axis types
6. call WFServiceServiceProxy.callModuleMethod (stacklightModuleName, methodName, converted parameters)

WFServiceServiceProxy—in callMOduleMethod( )
7. convert Axis-type parameters into Java object types→Object [ ] messageParams
8. Workflow Framework Module thisModule=lookup ‘stacklightMOduleName’ (StackLight1”) workflow module (if not found—throw an exception)
9. using ReflectionAPI, invoke the ‘nethodName’ nethod (“setStackLight’) with the ‘messageParams’ parameters
10. in this method is void—result is NULL, otherwise—result is an Object
11. return the result as an Axis type object

WFServiceClientProxy—in callModuleMethod( )
12. receive result from the WFServiceServerProxy
13. convert it into JAVA Object type or NULL
14. return to the WebClient

Asynchronous Call Process Flow:

WebClient:
String messageType=StackLight.SET_STACKLIGHT_MESSGE_TYPE
Create Collection messageParameters
methodParameters.put (color, stacklightTimeout, stacklightAction)
wfService.callModulePort (stacklightModuleName, messageType, messageParameters

WebServiceClientProxy—in callMoudulePort( )
SetStackLightMessage slMessage=new SetStackLightMessage(stacklightTimeout, color, stackLightAtion)
Convert slMessage into Axis type
Call WFServiceServerProxy.callModulePort(stacklightModuleName, slMessage)

WFSserviceServerProxy—in callModulePort (moduleName, message)
Convert Axis-type message into Java type Message→slMessage
Workflow Framework Module thisModule=lookup ‘stacklightModuleName’ (“StackLight1”) Workflow Framework module (if not found—throw an exception)
Call thisModule.receiveMessage (slMessage)

Workflow Module “StackLight1”—in receiveMessage(message slMessage)
Verify that the message is of a corrected type (StakLight.SET_STACKLIGHT_TYPE)
Do normal business logic
Upon completion, send HTTP notification with the results to all registered subscribers (this includes the WebClient)

WebClient
Receive result from the “stackLight1” workflow module as an HTTP notification

In One Exemplary Use Case:
1. the operator brings cases into the store back room and the time of their arrival are recorded by the system
2. the operator picks a case in the back room and caries it into the front room
3. if the case is not the oldest case among the cases of the same product—a warning is displayed on the operator-facing screen and, if necessary, active other alerts (stacklight, horn, etc.); the system records the accident

Participants Cases:
1. RFID edge server and Directional Portal Workflow Framework module tracking cases coming into store back room (BackRoomModule), Directional Portal workflow module tracking cases coming from the back room into the store front room (FrontRoomModule)
2. Web application serving as a client to RFID edge server and the workflow (Webclient)

Use Case:
1. BackRoomModule detects cases coming into the store back room, sends Observe Event to the WebClient (through HTTP notification)
2. WebClient receives the event, and stores it in a local cache along with a timestamp of the event's arrival; sets this item's status to “store” (or something like that).

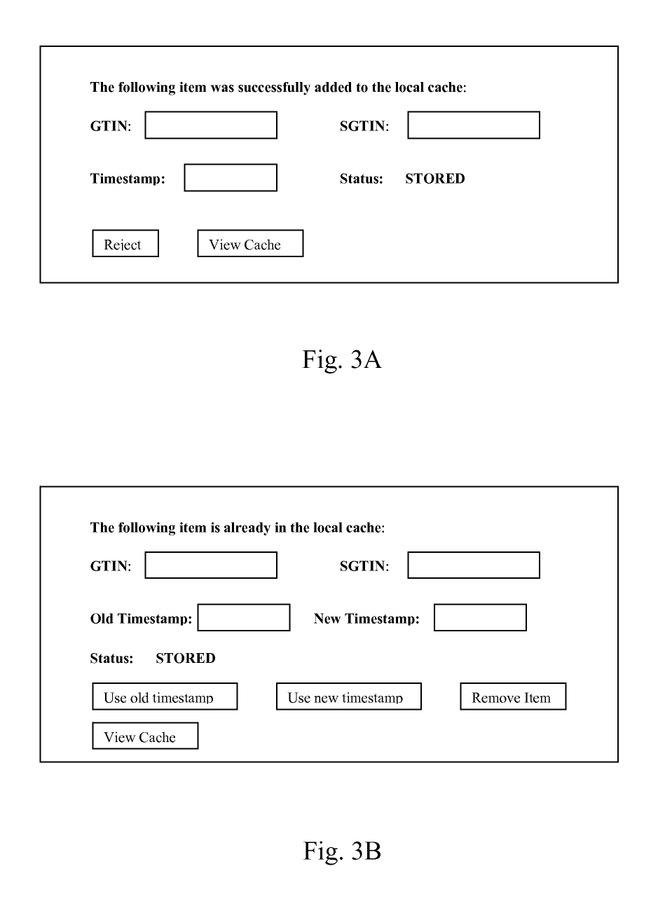

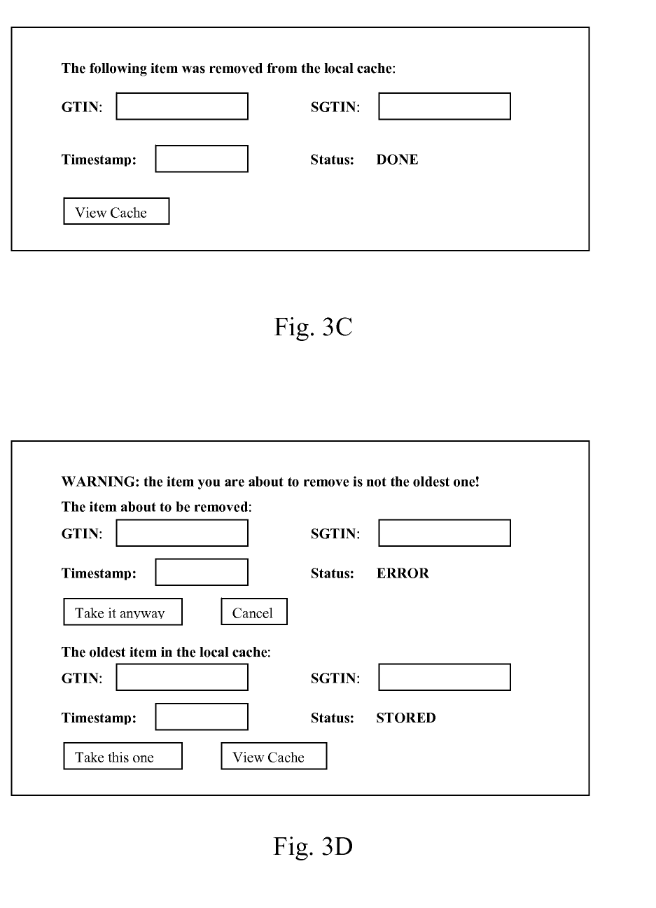

If the item was added to the cache successfully—show confirmation screen of FIG. 3A is shown.

Assumption: this is the first time we see this item; if this is not true—handle error (show a warning to the user on the screen and let them accept/reject the item as shown in FIG. 3B.)

As items are being moved to the front store room, FrontRoomModule can sent Observe Events to the Webclient.

As shown in figure for each Observe Event received from the FrontRoomModule, the WebClient can check whether this case was recorded in the local cache and whether this is the oldest item in the cache for this product group and whose status is not equal to “done”. If it is the status of this item can be set as “done” in the local cache and send to Observer event to EPCIS as shown in FIG. 3C.

If the item was not found in the local cache, or it was not the oldest item, set the item's status as “error”, display a warning on the screen as shown in FIG. 3D, do some other alerts if necessary (stacklight, horn etc.), send the ObserveEvent to EPCIS.

The system can allow users to view and modify the cache content (set different timestamps, change item status, remove items, etc.) The screen can be displayed when a user presses the “View Cache” button:

Use Case:
1. Advanced Shipping Notices (ASNs) can be received beforehand and stored locally
2. the operator can push the “Start Reading” button on the screen
3. one pallet is being brought in
4. the pallet's Serialized Shipping Container Codes (SSCC) and/or Serialized Global Trade Identification Numbers (SGTINs) can be read and a corresponding ASN is being looked up from the local cache
5. {optional] if no ASN is found this ASN can be looked up from the Warehouse Management Software (WMS)
6. if still no ASN if found
   a) the pallet's content can be displayed on the screen
   b) the screen can allow the user to accept/reject individual cases in the pallet
7. if ASN if found:
   a) ASN information can be displayed on the screen
   b) Expected vs actual pallet content can be display on the screen in a table format (Expected, seen, missing and extra Global Trade Identification Numbers (GTINs) and SGTINs can be displayed)
   c) the screen can allow the user to accept/reject individual cases in the pallet
   d) If expected content is equal to the actual content—the green light on the stacklight can be turned on
8. the operator presses an “Accept” button to finish processing the pallet or a “Cancel” button to discard all work with this pallet.

Use Case Implementation Details:
1. ASNs can be received via either HTTP notification or Comma Separated Values (CSV) file upload and stored in the local cache; ASNCache can be accessible to the WebClient. Options for implementing the local cache can include ServletContext, light-weight database like Cloudscape, file storage.
2. WebClient can provide a screen where a user can push a “Start Reading” button to start processing pallets and cases.
3. One pallet starts—SSCC and/or SGTINs can be read by RFID edge server and observe events can be sent to the WebClient
   3a. [alternative]—instead of sending Observe event, the RFID edge server could send ECReports directly.
4. when the WebClient receives the first observe event—it can look up a corresponding ASN from the ASNCache based on SSCC (or SGTIN) and use this ASN as the “In-process ASN”; the SSCC or SGTIN can be stored in the EPCCache
   If ASN was found—the system can continue in the “ASN-present” mode
   Otherwise:
   4a. [optional] no ASN could be found for this SSCC in the local cache—the system can try to look up ASN from a WMS or continue in the “ASN-absent” mode
5. for all subsequent Observe events received
   a) SSCC or SGTIN can be stored in the EPCCache
   b) ASN for the current SGTIN or SSCC can be looked up from the local cache
   c) If no ASN if found the system can try to look it up from the WMS
   d) If still not fount the system can continue in the “ASN-absent” mode
   e) If ASN is found: if it is the same as the “In-process ASN” the system can continue in the “ASN-present mode; if not (display alerts, let user ignore the item . . . )
6. based on the mode:
   “ASN-present” mode:
   1) The system can display ASN info on the screen (should stay in the same for the duration of the pallet processing)
   2) The system can display expected vs. actual pallet content grouped by GTINs using information from the ASNCache and EPCCache. This information can be updated periodically or whenever a new event is received. Approaches to handle screen updates can include:
      place dynamic information into a frame and update this frame whenever a new Observe event is received, except when the user is modifying something in the frame (focus is in)
      the same as above, but used applet instead of frames
      the same as above, but use AJAX for the dynamic reloading of one part of the screen
      do not update the screen on each event arrival, but rather update it periodically at predetermined time intervals
      update the screen only when a user presses “Refresh” button provided on the screen
   3) if expected content is equal to the actual content a “green” color can be light on a stacklight by sending a request to the RFID edge server and the workflow and display a success message of the screen
   “ASN-absent” mode”:
   1) can display actual pallet content grouped by GTINs
7. WebClient can provide “Accept” and “Cancel” buttons on the screen:
   If “Accept” button is pressed:
      [optional] A aggregate event can be created and sent to EPCIS
   If “cancel” button is pressed:
      Provide users with a pop-up window (or a new screen) to add “reason” notes. The notes can be stored as an extension to the Aggregate Event.

CPA Verification
1) an external process can populate EPCIS database with the expected CPAs (either as Aggregate Events sent to EPCIS from some application like CJS, or via imported CSV files, ASNs, etc.)
2) on the receiving side, RFTA and Directional Portal workflow module can be responsible for reading incoming data (pallets and cases) and sending Aggregate Events to subscribers via either JMS or HTTP notifications.
3) A thin client application can have a capturing component listening for notifications from RFID edge server and the workflow. It can extract Aggregate Events from the notifications and store them in a local cache.
4) The thin client application can also have a UI component (JSP) that periodically does the following:
   Read collected aggregate events from the local cache
   For each parent-child association seen it can determine whether a corresponding CPA exists in the EPSIS database by querying EPCIS database via the EPCIS Query interface
   Display a summary information for the last seen aggregate event (seen pallet) grouped by products (GTINs). For each GTIN, the following information is displayed: expected, seen, missing and extra cases.
   Buttons can be provided to allow the user to: override not seen SGTINs as seen (update corresponding EPCIS database tables)—“Submit” button; clear out local cache and start collecting from scratch—“Rescan” button; cancel whatever changes user made so far—“Cancel” button
   In the case of extra tags seen—user should be able to either accept (with the EPCIS database update to follow) or reject them (and remove them from the local cache)

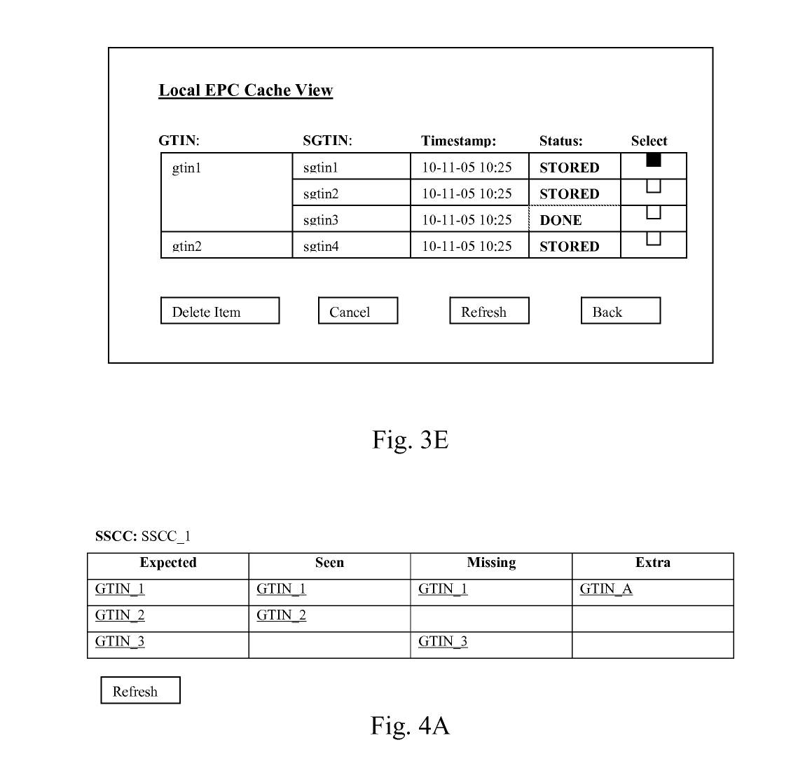

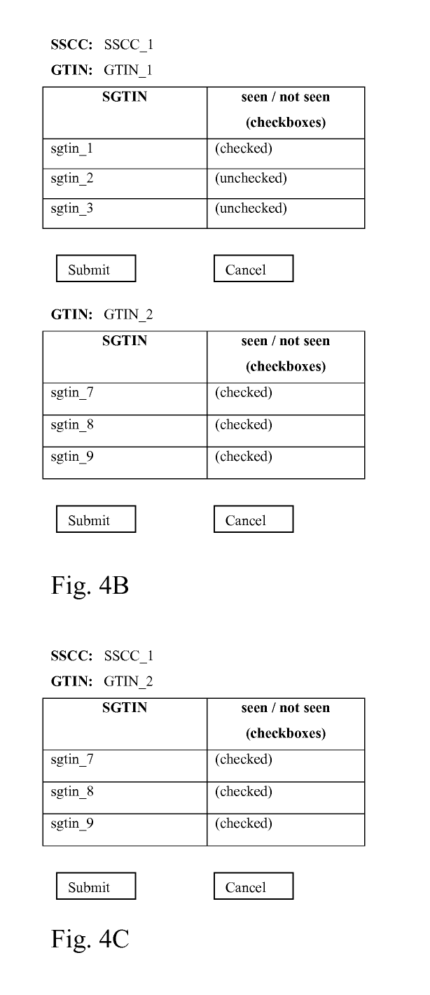

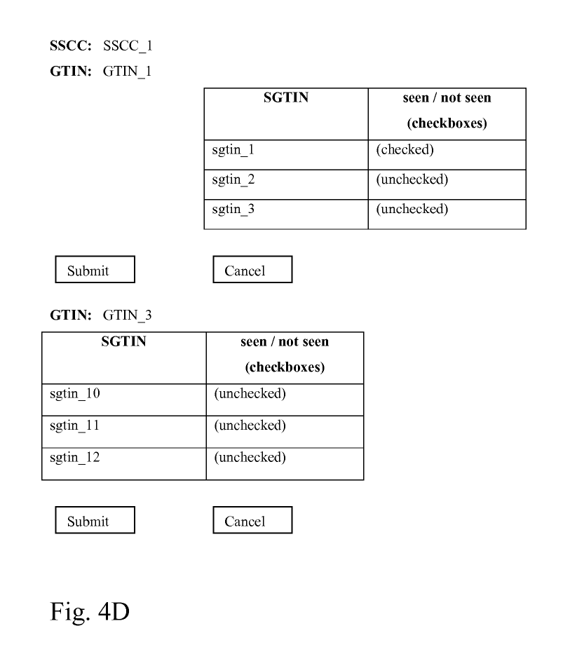

The following set of screens can be used for this use case: FIG. 4A is Main screen that can be refreshed by either reloading the page in the browser or by pressing the “Refresh” button. If a new aggregate event were received in the meantime, it will be used to the data displayed on the screen.

This table displays information for one Pallet only (one Serial Shipping Container Code (SSCC)). We are assuming here that we are dealing with the last seen pallet. If this is not acceptable, one way to select a pallet of interest could be to let users type in SSCC directly, or give them some kind of a menu with available SSCCs.

Each GTIN can be a link. When a user clicks on the links, detailed screens specific to the column type can be opened.

FIG. 4B screen for Expected GTINS. The last column will contain checkboxes; checked for screen SGTINs, unchecked—for not seen SGTINs.

Users can force not-seen SGTINs to be considered as seen by checking off corresponding checkboxes and pressing the “Submit” button. In a similar manner, seen SGTINs can be set as not seen. “Cancel” button will undo any changes the user might have made.

FIG. 4C screen 3 for Seen GTINs:
SSCC: SSCC_1
GTIN: GTIN_2

FIG. 4D screen for Missing GTINs:
SSCC: SSCC_1
STIN: STIN_1
GTIN: GTIN_3

FIG. 4E screen for Extra GTINs: In checked checkboxes are used for accepted SGTINs, uncheck—for not accepted SGTINs. If at least one SGTIN per GTIN is accepted—the corresponding GTINS can be accepted as well. If all SGTINs are rejected—the corresponding FTIN can be rejected as well.

One embodiment may be implemented using a conventional general purpose of a specialized digital computer or microprocessor(s) programmed according to the teachings of the present disclosure, as will be apparent to those skilled in the computer art. Appropriate software coding can readily be prepared by skilled programmers based on the teachings of the present discloser, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. A computer-based system comprising:
an RFID edge server receiving RFID data from at least one RFID reader;
a thin client application communicating with the RFID edge server, the thin client running in an application container and provides for a UI display.

2. The computer-based system of claim 1, wherein the edge server uses a workflow.

3. The computer-based system of claim 1, wherein the thin client application is in a web container.

4. The computer-based system of claim 1, wherein the thin client application is in a J2EE application container.

5. The computer-based system of claim 1, wherein the thin client application placed in an archive file.

6. The computer-based system of claim 1, wherein the RFID edge server runs in the application container.

7. The computer-based system of claim 1, wherein the RFID edge server runs in the application container and different application container.

8. The computer-based system of claim 1, wherein the thin client application includes a listener.

9. The computer-based system of claim 1, wherein the thin client application communicates with an RFID Enterprise Server.

10. The computer-based system of claim 9, wherein the RFID Enterprise Server does EPCIS functions.

11. The computer-based system of claim 1, wherein the UI allows users to interact with an RFID workflow.

12. The computer-based system comprising:
a thin client application to run in an application server, the thin client application to communicate with an RFID edge server, the thin client application providing a UI display.

13. The computer-based system of claim 12, wherein the edge server using a workflow.

14. The computer-based system of claim 12, wherein the thin client application is in a J2EE application container.

15. The computer-based system of claim 12, wherein the thin client application placed in an archive file.

16. The computer-based system of claim 12, wherein the RFID edge server runs in the application container.

17. The computer-based system of claim 12, wherein the RFID edge server runs in the application container.

18. The computer-based system of claim 12, wherein the RFID edge server runs in the application container and different application container.

19. The computer-based system of claim 12, wherein the thin client application includes a listener.

20. The computer-based system of claim 12, wherein the thin client application communicates with an RFID Enterprise Server.

21. The computer-based system of claim 20, wherein the RFID Enterprise Server does EPCIS functions.

22. The computer-based system of claim 12, wherein the UI allows users to interact with an RFID workflow.

23. A computer-based system comprising:
an RFID workflow that uses RFID to do an RFID process; and
a web-based UI to interact with the RFID workflow.

24. The computer-based system of claim 23, wherein the RFID workflow is run from a RFID edge server.

25. The computer-based system of claim 23, wherein the web-based UI is part of a thin client.

26. The computer-based system of claim 25 wherein the thin client is a run on a container.
